(19) United States
(12) Patent Application Publication
(10) Pub. No.: US 2009/0191458 A1
(43) Pub. Date: Jul. 30, 2009

(54) POROUS NETWORK NEGATIVE ELECTRODES FOR NON-AQUEOUS ELECTROLYTE SECONDARY BATTERY

(75) Inventor: P. Subramanya Herle, Mountain View, CA (US)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/177,442

(22) Filed: Jul. 22, 2008

Related U.S. Application Data
(60) Provisional application No. 60/961,638, filed on Jul. 23, 2007.

(51) Int. Cl. H01M 6/14; H01M 4/58; H01M 4/02

(52) U.S. Cl. 429/207; 429/218.1; 429/231.5; 429/209; 429/231.8; 429/231.95; 977/700; 977/932

(57) ABSTRACT

An electrode of a non-aqueous electrolyte secondary battery comprises a current collector and a mixture comprising an electrode active material, a conductive material, and a binder on the current collector. The electrode active material comprises a porous oxide, in which the porous oxide comprises a lithium absorbing nano-material. The electrode active material is used in the electrodes of non-aqueous secondary batteries, preferably as the negative electrode active material.

### CROSS REFERENCE TO RELATED APPLICATIONS

This application claims priority of U.S. Provisional Application 60/961,638, filed Jul. 23, 2007, the disclosure of which is incorporated herein by reference.

### FIELD OF THE INVENTION

This invention relates to non-aqueous secondary batteries.

### BACKGROUND OF THE INVENTION

Cordless portable electronic devices, such as personal computers, cell phones, and personal digital assistants (PDA), as well as audio-visual electronic devices, such as video camcorders and mini-disk players, are rapidly becoming smaller and lighter in weight. Because these devices are designed to be light weight and compact, a demand for compact and light weight secondary batteries that have a higher energy density than that obtainable by conventional lead-acid batteries, nickel-cadmium storage batteries, or nickel-metal hydride storage batteries has developed.

Non-aqueous electrolyte secondary batteries have been extensively developed to meet this demand. Although lithium is the best candidate for the anode material (3860 mAh/g), repeated dissolution and deposition of lithium during discharging and charging cycles, causes the formation of dendritic lithium on the surface of lithium. Dendrites decrease charge-discharge efficiency and can pierce the separator and contact the positive electrode, causing a short circuit and unacceptably shortening the life of the battery. In addition, the circuit density is high at the end of a dendrite, which can cause decomposition of the non-aqueous solvent.

Carbon materials, such as graphite, capable of absorbing and desorbing lithium have been used as the negative electrode active material in lithium non-aqueous electrolyte secondary batteries. When a graphite material is used as the negative electrode active material, lithium is released at an average potential of about 0.2 V. Because this potential is low compared to non-graphite carbon, graphite carbon has been used in applications where high cell voltage and voltage flatness are desired. However, the search for alternate anode materials is continuing because the theoretical discharge capacity of graphite is about 372 mAh/g. Thus, these batteries cannot meet the demand for high energy density required for many light weight mobile electrical and electronic devices.

Materials that are capable of absorbing and desorbing lithium and showing high capacity include simple substances such as silicon and tin. Elemental silicon and elemental tin are each high energy density materials that react with lithium at low voltage with respect to Li/Li+. However, silicon and tin each have an enormous volume expansion problem. When the battery case has low strength, such as a prismatic case made of aluminum or iron, or an exterior component which is made of an aluminum foil having a resin film on each face thereof (i.e., an aluminum laminate sheet), the battery thickness increases due to volume expansion of the negative electrode, such that an instrument storing the battery could be damaged. In a cylindrical battery using a battery case with high strength, because the separator between a positive electrode and a negative electrode is strongly compressed due to volume expansion of the negative electrode and can cause rupture of the separator film, an electrolyte-depleting region is created between the positive electrode and the negative electrode, thereby making the battery life even shorter.

However, it is desirable to have anode material having a larger free volume for Li⁺-ion motion within the host structure without much change in the host structure. An inexpensive, non-polluting compound would make the battery environmentally benign. Thus, there is a continuing need for alkali-ion batteries that do not have volume expansion problems.

### SUMMARY OF THE INVENTION

According to one aspect of the present invention, the invention is an electrode material for a non-aqueous secondary battery, an electrode comprising the material, and a non-aqueous secondary battery that comprises the electrode material. The electrode material comprises a porous oxide that contains a lithium absorbing nano-material.

In one aspect, the invention is an electrode of a non-aqueous electrolyte secondary battery, the electrode comprising:

a current collector; and

a mixture comprising an electrode active material, a conductive material, and a binder on the current collector;

in which:
the electrode active material comprises a porous oxide, in which the porous oxide comprises a lithium absorbing nano-material.

In another aspect, the invention is an electrode of a non-aqueous electrolyte secondary battery, the electrode comprising:

a current collector; and

a mixture comprising an electrode active material, a conductive material, and a binder on the current collector;

in which:
the electrode active material comprises a porous network of an oxide, in which the porous network comprises nanoparticles of a lithium absorbing material.

In another aspect, the invention is a non-aqueous electrolyte secondary battery comprising:

a positive electrode;

a negative electrode; and

a non-aqueous electrolyte between the positive electrode and the negative electrode;

in which:
the non-aqueous electrolyte comprises a non-aqueous solvent and lithium salt;
the positive electrode comprises a positive electrode current collector, and, on the positive electrode current collector, a mixture comprising a positive electrode active material, a first conductive material, and a first binder;
the negative electrode comprises a negative electrode current collector, and, on the negative electrode current collector, a mixture comprising a negative electrode active material, a second conductive material, and a second binder; and
either the negative electrode active material or the positive electrode active material comprises a porous network of an oxide, in which the porous network comprises nanoparticles of a lithium absorbing material.

### BRIEF DESCRIPTION OF THE DRAWING

FIG. 1 is a schematic drawing of a non-aqueous electrolyte secondary battery.

FIG. 2 shows a TG/DSC analysis of dried gel 1-7 shown in Tables 1 and 2 in Example 1.

FIG. 3 shows a low angle powder XRD (Cu Kα) diffraction pattern for heat treated Si/TiO₂/P123 gel at 400° C. in 1% H₂/Ar for 4 hr.

FIG. 4 shows a low angle powder XRD (Cu Kα) diffraction pattern for Si/TiO₂/P123 gel heat treated at 400° C. in 1% H₂/Ar for 4 hr.

FIG. 5 shows a powder X-ray diffraction pattern for heat treated gel in 1% H₂/Ar atmosphere.

FIG. 6 is a plot of BET absorption/desorption for the nano-Si/TiO₂/C composites.

FIG. 7 shows BJH analysis of the composites.

FIG. 8 shows a comparison of 10th cycle voltage vs capacity for various nano-Si/TiO₂/C composites.

FIG. 9 shows the 5^{th} cycle 1 C voltage vs. capacity curve for nano-Sn/TiO₂/C composites.

FIG. 10 shows the CV measurement for tin containing sample 3-2 in Table 3 of Example 3.

FIG. 11 shows the powder XRD for the nano-Al samples in Example 5.

FIG. 12 shows the low angle XRD (Cu Kα) diffraction for the nano-Al samples in Example 5.

FIG. 13 shows the BET surface area analysis of the samples in Example 5.

FIG. 14 shows the BJH analysis for the samples in Example 5.

FIG. 15 shows the voltage vs. capacity curve for the nano-Si/TiO₂/C composite with carbon nanotubes for sample 8-2 in Example 6.

### DETAILED DESCRIPTION OF THE INVENTION

Unless the context indicates otherwise, in the specification and claims, the terms binder, conductive material, negative electrode active material, positive electrode active material, lithium salt, non-aqueous solvent, additive, and similar terms also include mixtures of such materials. Unless otherwise specified, all percentages are percentages by weight and all temperatures are in degrees Centigrade (degrees Celsius). The term “mesoporous” refers to a porous material with a predominant pore distribution in the range from 2 nm to 50 nm. Materials with a predominant pore distribution less than 2 nm may be considered microporous. Materials with a predominant pore distribution exceeding about 50 nm may be considered macroporous. The term “porous” refers to any porous materials with a predominant pore distribution in the mesoporous, macroporous or microporous ranges. It is noted that the terms mesoporous, microporous, and macroporous are not rigidly defined in the art and may change according to the context. The porous materials of the present invention may have a predominant pore distribution up to about 100 nm. The present invention also contemplates a distribution of pores in the different distributions. This is particularly evident with pores in the mesoporous and macroporous ranges.

The invention relates to the use of porous network materials as electrode materials in non-aqueous secondary batteries. In one aspect, the invention is an electrode material for a rechargeable secondary battery comprising a positive electrode, a negative electrode, an electrolyte, and optionally an electrode separator in which the battery comprises a porous electrode material. The porous electrode material may be either a positive electrode material or a negative electrode material. However, the material is preferably useful in the negative electrode.

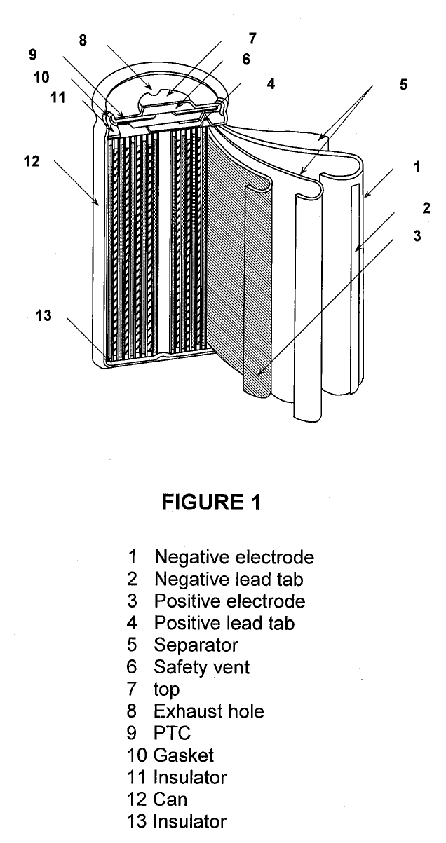

Referring to FIG. 1, the non-aqueous secondary battery comprises negative electrode 1, negative lead tab 2, positive electrode 3, positive lead tab 4, separator 5, safety vent 6, top 7, exhaust hole 8, PTC (positive temperature coefficient) device 9, gasket 10, insulator 11, battery case or can 12, and insulator 13. Although the non-aqueous secondary battery is illustrated as cylindrical structure, any other shape, such as prismatic, aluminum pouch, or coin type may be used.

### Negative Electrode

Negative electrode 1 comprises a current collector and, on the current collector, a mixture comprising a negative electrode active material, a conductive material, and a binder.

The current collector can be any conductive material that does not chemically change within the range of charge and discharge electric potentials used. Typically, the current collector is a metal such as copper, nickel, iron, titanium, or cobalt; an alloy comprising at least one of these metals such as stainless steel; or copper or stainless steel surface-coated with carbon, nickel or titanium. The current collector may be, for example, a film, a sheet, a mesh sheet, a punched sheet, a lath form, a porous form, a foamed form, a fibrous form, or, preferably, a foil. A foil of copper or a copper alloy, or a foil having a copper layer deposited on its surface by, for example electrolytic deposition, is preferred. The current collector is typically about 1-500 μm thick. It may also be roughened to a surface roughness of Ra is 0.2 μm or more to improved adhesion of the mixture of the negative electrode active material, the conductive material, and the binder to the current collector.

The negative electrode active material comprises a porous oxide or a porous network of an oxide, in which the porous oxide or porous network comprises lithium absorbing nano-materials. The porous oxide or a porous network of an oxide may include a metal oxide or a non-metal oxide. For example, preferable oxides include titanium dioxide, silicon oxides, or aluminum oxides. These may be of the formulas Ti₁₋ₓSiₓO₂ or Ti₁₋ₓAlₓO_{y}. The oxide, especially TiO₂, may be anatase, rutile polymorph, or amorphous. These porous materials typically have high surface areas (˜100-800 m²/g).

Lithium absorbing nano-materials may include any material capable of absorbing lithium. The nano-material may include a nano-dimensional material, a nanoparticle, “partially nanoparticle,” a nano-ribbon, a nano-rod, a nano-wisker, or a nanotube. Nano-dimensional materials encompass materials which are measurable on a nano-scale in length in at least one dimension, e.g., nano-sized materials. To further illustrate nano-dimensional materials, for the case of a reduced metal salt, such as a tin salt reduction under H₂—Ar atmosphere, the material is measurable on a nano-scale in length in at least one dimension. Nanoparticles may be partially amorphous. “Partially nanoparticle” may include agglomerated nano-particles. Suitable lithium absorbing nano-materials may include nanoparticles of a lithium absorbing material such as tin nanoparticles, silicon nanoparticles, aluminum nanoparticles, or a mixture of such materials, or may include lead, bismuth, antimony, indium, germanium, Mg, MgH₂, Si alloys, or other similar materials. The negative electrode active material may further comprise nanotubes, more specifically carbon nanotubes (CNT), and more particularly multi-walled carbon nanotubes. Nanotubes are well known in the art and are defined by their ordinary and customary meaning.

At least part of the surface of the negative electrode active material is covered with a conductive material. Any conductive material known in the art can be used. Typical conductive materials include carbon, such as graphite, for example, natural graphite (scale-like graphite), synthetic graphite, and expanding graphite; carbon black, such as acetylene black, KETZEN® black (highly structured furnace black), channel black, furnace black, lamp black, and thermal black; conductive fibers such as carbon fibers and metallic fibers; metal powders such as copper and nickel; organic conductive materials such as polyphenylene derivatives; and mixtures thereof. Synthetic graphite, acetylene black, and carbon fibers are preferred.

The binder for the negative electrode can be either a thermoplastic resin or a thermosetting resin. Useful binders include: polyethylene, polypropylene, polytetrafluoroethylene (PTFE), polyvinylidene fluoride (PVDF), styrene/butadiene rubber, tetrafluoroethylene/hexafluoropropylene copolymers (FEP), tetrafluoroethylene/perfluoro-alkyl-vinyl ether copolymers (PFA), vinylidene fluoride/-hexafluoropropylene copolymers, vinylidene fluoride/chlorotrifluoroethylene copolymers, ethylene/tetrafluoroethylene copolymers (ETFE), polychlorotrifluoroethylene (PCTFE), vinylidene fluoride/pentafluoropropylene copolymers, propylene/tetrafluoroethylene copolymers, ethylene/-chlorotrifluoroethylene copolymers (ECTFE), vinylidene fluoride/hexafluoropropylene/-tetrafluoroethylene copolymers, vinylidene fluoride/perfluoromethyl vinyl ether/-tetrafluoroethylene copolymers, and mixtures thereof. Polytetrafluoroethylene and polyvinylidene fluoride are preferred binders.

Negative electrode 1 may be prepared by mixing the negative electrode active material, the binder, and the conductive material with a solvent, such as N-methyl pyrrolidone. The resulting paste or slurry is coated onto the current collector by any conventional coating method, such bar coating, gravure coating, die coating, roller coating, or doctor knife coating. Typically, the current collector is dried to remove the solvent and then rolled under pressure after coating. The mixture of negative electrode active material, binder, and conductive material typically comprises the negative electrode active material, at least enough conductive material for good conductivity, and at least enough binder to hold the mixture together. The negative electrode active material may typically comprise from about 1 wt % to about 99 wt % of the mixture of negative electrode active material, binder, and conductive material.

The porous network may be the positive electrode material. When the porous network is the positive electrode material, the negative electrode material may be, for example, a carbonaceous material, such as coke, artificial graphite, or natural graphite. The negative electrode is prepared by mixing the negative electrode active material, a binder, and a conductive material with a solvent and coating on a current collector as described above.

### Preparation of Porous Networks

Porous networks of oxide materials can be synthesized by using a suitable template (surfactants, block co-polymers, liquid crystals, ionic liquids, ice crystal at the critical transition temp. proteins, etc) and metal alkoxides in general. Composite structural materials having a mesoporous network were recently investigated by Sugnaux, U.S. Pat. Publication No. 2004/0131934 A1, the disclosure of which is incorporated herein by reference, and Hambitzer, U.S. Pat. Publication No. 2005/0106467 A1, the disclosure of which is incorporated herein by reference. Synthesis of mesoporous networks is also disclosed in Liu, U.S. Pat. No. 5,645,891, the disclosure of which is incorporated herein by reference; Stucky, U.S. Pat. No. 6,592,764, the disclosure of which is incorporated herein by reference; and Yu, U.S. Pat. No. 6,803,077, the disclosure of which is incorporated herein by reference.

For example, in the porous networks of the invention, a surfactant, such as a block copolymer, is added to an organic solvent, such as methanol or ethanol. At least one lithium absorbing nano-material is added. More specifically, for example, nanoparticles of silicon, nanoparticles of aluminum, or in-situ generated from metal salts such as tin from its salts, e.g., SnCl₄.5H₂O, stannic acetate, a tin (+4) alkoxide such as tin (+4) tert-butoxide, or an aluminum alkoxide such as aluminum iso-propoxide, or a silicon alkoxide such as tetraethyl orthosilicate may be added. Nanotubes such as carbon nanotubes may also be added to the mixture. The mixture is made acidic, typically pH<1, by the addition of a strong acid such as hydrochloric acid. When nano-materials are added, they are thoroughly dispersed by, for example, ultrasound dispersion. An alkoxide, such as titanium ethoxide, titanium iso-propoxide, or titanium n-butoxide is added to form a gel. The gel is aged and dried. Other networks, for example networks of zirconium oxide, may also be used.

Then the dried gel is heated, for example at 400° C. to 1000° C., in a reducing atmosphere, for example 1% hydrogen in argon. This produces a nano-material in the porous network of an oxide. As shown in the Examples, the nanoparticles of silicon, the nanoparticles of tin, and the nanoparticles of aluminum are each capable of absorbing and desorbing lithium to produce nano-materials that comprise absorbed lithium. When these nano-materials absorb lithium, the thickness expansion (or volume expansion) of the electrode upon charging expands less than 20% for the first few charging cycles.

When the synthesis is carried out in a reducing atmosphere, decomposition of the surfactant leaves amorphous carbon in the porous network as well as some partially decomposed surfactant. Therefore, the nanoparticle-containing porous network also comprises some amorphous carbon or practically graphitized carbon and some partially decomposed surfactant.

### Positive Electrode

Positive electrode 3 typically comprises a current collector and, on the current collector, a mixture comprising a positive electrode active material, a conductive material, and a binder. Typical current collectors, conductive materials, and binders for the positive electrode include the current collectors, conductive materials, and binders described above for the negative electrode.

As noted above, the positive electrode active material may be the porous network. However, when the negative electrode active material is the porous network, the positive electrode active material may include any compound containing lithium that is capable of occluding and of releasing lithium ions (Li⁺). A transition metal oxide, with an average discharge potential in the range of 3.5 to 4.0 V with respect to lithium, has typically been used. As the transition metal oxide, lithium cobalt oxide (LiCoO₂), lithium nickel oxide (LiNiO₂), lithium manganese oxide (LiMn₂O₄), a solid solution material (LiCoₓNi_{y}Mn_{z}O₂, Li(CoₐNi_{b}Mn_{c})₂O₄) with a plurality of transition metals introduced thereto, and the like, may be used. The average diameter of particles of the positive electrode active material is preferably about 1-30 μm.

Positive electrode 3 can be prepared by mixing the positive electrode active material, the binder, and the conductive material with a solvent and coating the resulting slurry on the current collector as was described for preparation of the negative electrode.

In the non-aqueous electrolyte secondary battery, it is preferred that at least the surface of the negative electrode comprising the negative electrode active material is oriented to face the surface of the positive electrode comprising the positive electrode active material. Further, the electrodes are separated by a porous separator as an electrical insulator and allow lithium ions and solvent molecules may pass though. Generally, in a solid state battery, the separator is insulating but is a lithium-ion conducting ceramic. A polymeric gel separator can also be used.

### Non-Aqueous Electrolyte and Separator

The non-aqueous electrolyte is typically capable of withstanding a positive electrode that discharges at a high potential of 3.5 to 4.0 V and also capable of withstanding a negative electrode that charges and discharges at a potential close to lithium. The non-aqueous electrolyte comprises a non-aqueous solvent, or mixture of non-aqueous solvent, with a lithium salt, or a mixture of lithium salts, dissolved therein.

Typical non-aqueous solvents include, for example, cyclic carbonates as ethylene carbonate (EC), propylene carbonate (PC), dipropylene carbonate (DPC), butylene carbonate (BC), vinylene carbonate (VC), phenyl ethylene carbonate (ph-EC), and vinyl ethylene carbonate (VEC); open chain carbonates as dimethyl carbonate (DMC), diethyl carbonate (DEC), ethylmethyl carbonate (EMC); amides, such as formamide, acetamide, and N,N-dimethyl formamide; aliphatic carboxylic acid esters such as methyl formate, ethyl formate, methyl acetate, ethyl acetate, methyl propionate and ethyl propionate; diethers, such as 1,2-dimethoxyethane (DME), 1,2-diethoxyethane (DEE), and ethoxymethoxyethane (EME); cyclic ethers such as tetrahydrofuran, 2-methyl tetrahydrofuran, and dioxane; other aprotic organic solvents, such as acetonitrile, dimethyl sulfoxide, 1,3-propanesulton (PS) and nitromethane; and mixtures thereof. Typical lithium salts include, for example, lithium chloride (LiCl), lithium bromide (LiBr), lithium trifluoromethyl acetate (LiCF₃CO₂), lithium hexafluorophosphate (LiPF₆), lithium perchlorate (LiClO₄), lithium tetrafluoroborate (LiBF₄), lithium trifluoro-methansulfonate (LiCF₃SO₃), lithium hexafluoroarsenate (LiAsF₆), bis(trifluoromethyl)sulfonylimido lithium [LiN(CF₃SO₂)₂], lithium bisoxalato borate (LiB(C₂O₄)₂), and mixtures thereof.

Preferably, the non-aqueous electrolyte is one obtained by dissolving lithium hexafluoro phosphate (LiPF₆) in a mixed solvent of ethylene carbonate (EC), which has a high dielectric constant, and a linear carbonate or mixture of linear carbonates that are low-viscosity solvents, such as, for example, diethyl carbonate (DEC), dimethyl carbonate (DMC), ethyl methyl carbonate (EMC). The concentration of lithium ion in the non-aqueous electrolyte is typically about 0.2 mol/l to about 2 mol/l, preferably about 0.5 mol/l to about 1.5 mol/l.

Other compounds may be added to the non-aqueous electrolyte in order to improve discharge and charge/discharge properties. Such compounds include triethyl phosphate, triethanolamine, cyclic ethers, ethylene diamine, pyridine, triamide hexaphosphate, nitrobenzene derivatives, crown ethers, quaternary ammonium salts, and ethylene glycol di-alkyl ethers.

Separator 5 is insoluble and stable in the electrolyte solution. It prevents short circuits by insulating the positive electrode from the negative electrode. Insulating thin films with fine pores, which have a large ion permeability and a predetermined mechanical strength, are used. Polyolefins, such as polypropylene and polyethylene, and fluorinated polymers such as polytetrafluoroethylene and polyhexafluoropropylene, can be used individually or in combination. Sheets, non-wovens and wovens made with glass fiber can also be used. The diameter of the fine pores of the separators is typically small enough so that positive electrode materials, negative electrode materials, binders, and conductive materials that separate from the electrodes can not pass through the separator. A desirable diameter is, for example, 0.01-1 μm. The thickness of the separator is generally 10-300 μm. The porosity is determined by the permeability of electrons and ions, material and membrane pressure, in general however, it is desirably 30-80%.

For polymer secondary batteries, gel electrolytes comprising these non-aqueous electrolytes retained in the polymer as plasticizers, may also be used. Alternatively, the electrolyte may be polymer solid electrolyte or gel polymer electrolyte, which comprises a polymer solid electrolyte mixed with organic solvent provided as a plasticizer. Effective organic solid electrolytes include polymer materials such as derivatives, mixtures and complexes of polyethylene oxide, polypropylene oxide, polyphosphazene, polyaziridine, polyethylene sulfide, polyvinyl alcohol, polyvinylidene fluoride, polyhexafluoropropylene. Among inorganic solid electrolytes, lithium nitrides, lithium halides, and lithium oxides are well known. Among them, Li₄SiO₄, Li₄SiO₄—LiI—LiOH, xLi₃PO₄-(1-x)Li₄SiO₄, Li₂SiS₃, Li₃PO₄—Li₂S—SiS₂ and phosphorus sulfide compounds are effective. A family of lithium excess garnet with the general formula Li₇La₃Zr₂O₁₂ described in R. Murugan, V. Thangadurai and W. Weppner, Angew. Chem. Int. Ed. Engl. 2007, 46, 7778-7781 herein incorporated by reference, may also be used as solid electrolytes. When a gel electrolyte is used, a separator is typically not necessary.

Negative electrode 1, positive electrode 3, separator 5, and the electrolyte are contained in battery case or can 12. The case may be made of example, titanium, aluminum, or stainless steel that is resistant to the electrolyte. As shown in FIG. 1, a non-aqueous secondary battery may also comprise lead tabs, safety vents, insulators, and other structures.

### INDUSTRIAL APPLICABILITY

This invention provides a negative electrode for a non-aqueous secondary battery and a non-aqueous secondary battery of high reliability and safety. These non-aqueous secondary batteries are used in portable electronic devices such as personal computers, cell phones and personal digital assistants, as well as audio-visual electronic devices, such as video camcorders and mini-disk players.

The advantageous properties of this invention can be observed by reference to the following examples, which illustrate but do not limit the invention.

### EXAMPLES

### General Procedures

Powder XRD diffraction was recorded using a Bruker D-8 advance theta-theta diffractometer with Cu Kα radiation. The scintillation detector was attached with graphite monochrometer. The operating voltage was set for the diffractometer at 40 kV with 30 mA filament current. The surface area and pore size distribution was measured using Micromeritics Gemini 6 surface area and pore size analyzer. Thermogravimetic analysis and differential calorimetric measurements were performed on TA instrument Q50 and Q10 series respectively. Hitachi 3500 N Scanning Electron Microscope attached with Oxford INCA 350 EDX system was used to analyze the material for its morphology and composition.

### Example 1

This example illustrates the synthesis of a series of nano-Si/TiO₂/C composites with different amounts of silicon.

One gram of P-123 was taken in 100 mL glass jar and 8 g of ethanol was added to the jar and the contents were stirred. P-123 is PLURONIC® P-123, a triblock copolymer composed of ethylene oxide and propylene oxide (BASF, Florham Park, N.J. USA). The pH of the solution was adjusted by adding 0.3 g of 0.5 M hydrochloric acid solution. Around 1.9 g of titanium iso-propoxide was added drop wise with vigorous stirring under dry atmosphere and the gel was slowly formed and clear transparent monolith gel was formed. The gel was aged for 24 hr and dried in an oven at 60° C.-80° C. for 2 hr.

A series of nano-Si/TiO₂/C composites were synthesized by this process, except that nano-Si (˜5 nm) was added with the block-copolymer before the addition of titanium iso-propoxide. The nano-Si, P-123, and EtOH at a suitable pH was mixed thoroughly by ultrasound dispersion technique for the uniform distribution of the nano-particle and the gel was formed upon addition of titanium iso-propoxide with vigorous stirring. A resulting brown-colored gel was aged for 24 hr and dried in an oven at 60 C −80° C. for 2 hr. The amounts used are given in Table 1.

TABLE 1

| Sample | P-123 | Nano-Si | HCl (0.5 M) | Ti i-propoxide | EtOH | Si/TiO₂ |
|---|---|---|---|---|---|---|
| # | (g) | (g) | (g) | (g) | (g) | (%) |
| 1-1 | 1 | 0 | 0.3 | 1.9 | 8 | 0 |
| 1-2 | 1 | 0.0084 | 0.3 | 1.9 | 8 | 1.55 |
| 1-3 | 1 | 0.0169 | 0.3 | 1.9 | 8 | 3.06 |
| 1-4 | 1 | 0.0253 | 0.3 | 1.9 | 8 | 4.52 |
| 1-5 | 1 | 0.0337 | 0.3 | 1.9 | 8 | 5.94 |
| 1-6 | 1 | 0.0422 | 0.3 | 1.9 | 8 | 7.32 |
| 1-7 | 1 | 0.0506 | 0.3 | 1.9 | 8 | 8.65 |
| 1-8 | 1 | 0.06 | 0.3 | 1.9 | 8 | 10.10 |
| 1-9 | 1 | 0.063 | 0.3 | 1.9 | 8 | 10.55 |
| 1-10 | 1 | 0.0831 | 0.3 | 1.9 | 8 | 13.47 |
| 1-11 | 1 | 0.0891 | 0.3 | 1.9 | 8 | 14.30 |
| 1-12 | 1 | 0.0961 | 0.3 | 1.9 | 8 | 15.25 |

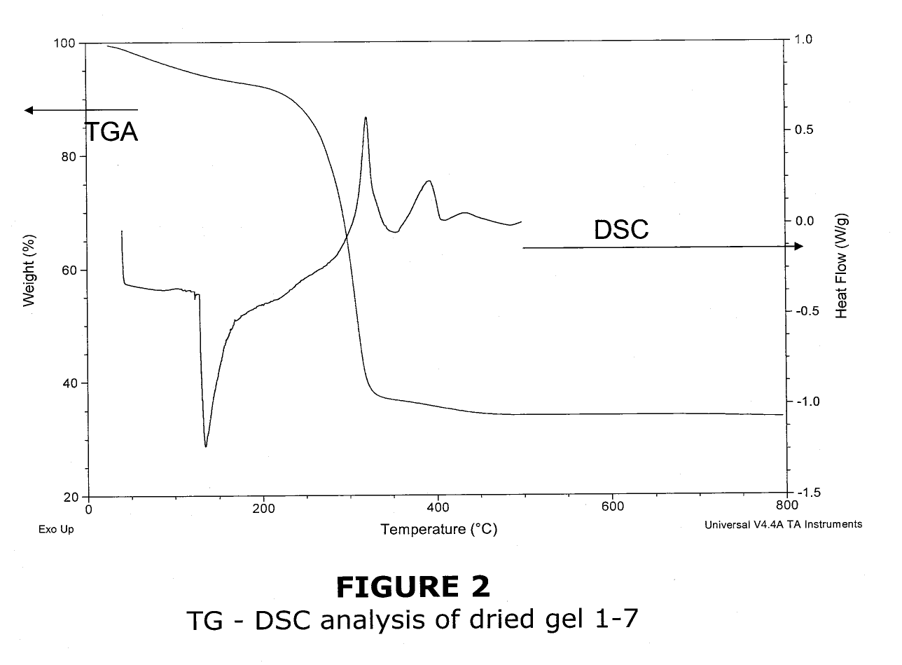

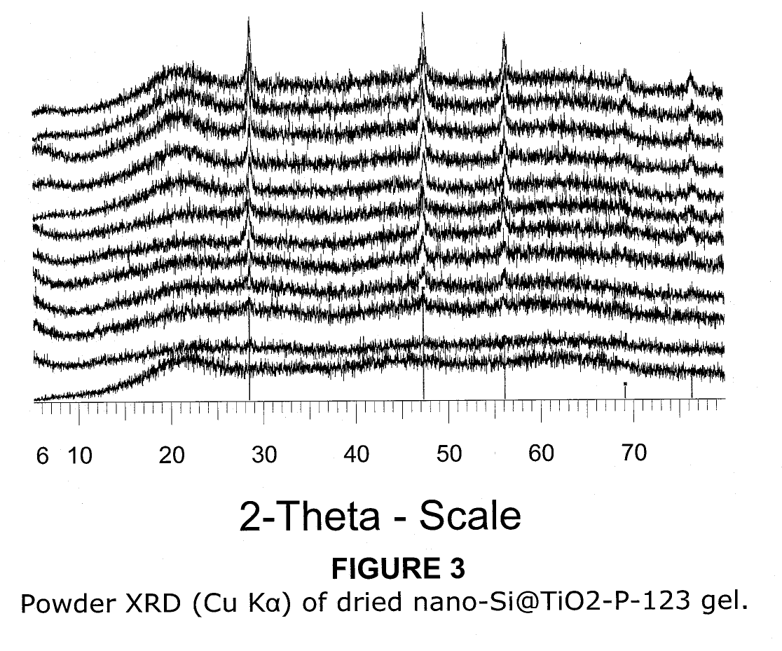

The dried gel was characterized using TG/DSC, powder XRD and SEM/EDX analysis system. FIG. 2 shows a TG/DSC analysis of dried gel 1-7, in which Si/TiO₂ is 8.65%. FIG. 3 shows a powder XRD (Cu Kα) of dried nano-Si/TiO₂/P-123 gel. The bottom diffraction pattern is for a control sample. Stacked diffraction patterns are arranged in ascending order from the bottom with increasing Si content.

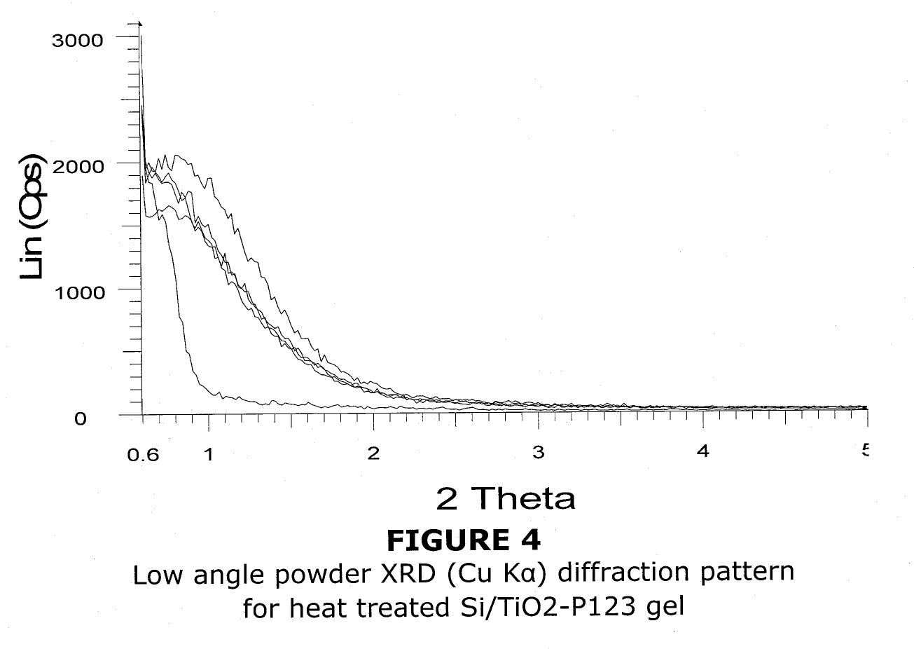

The dried gel was then heat treated at 400-550° C. for 4-12 hr in 1% H₂/Ar atmosphere and the resulted black porous material was investigated using BET surface area, powder XRD, SEM/EDX instruments. FIG. 4 shows a low angle powder XRD (Cu Kα) diffraction pattern for Si/TiO₂/P123 gel heat treated at 400° C. in 1% H₂/Ar for 4 hr. The top pattern is for the control sample without Si and remaining patterns for the 97 series of samples, with increasing Si content decrease low angle diffraction intensity around 0.6 to 1 degree in 2 theta.

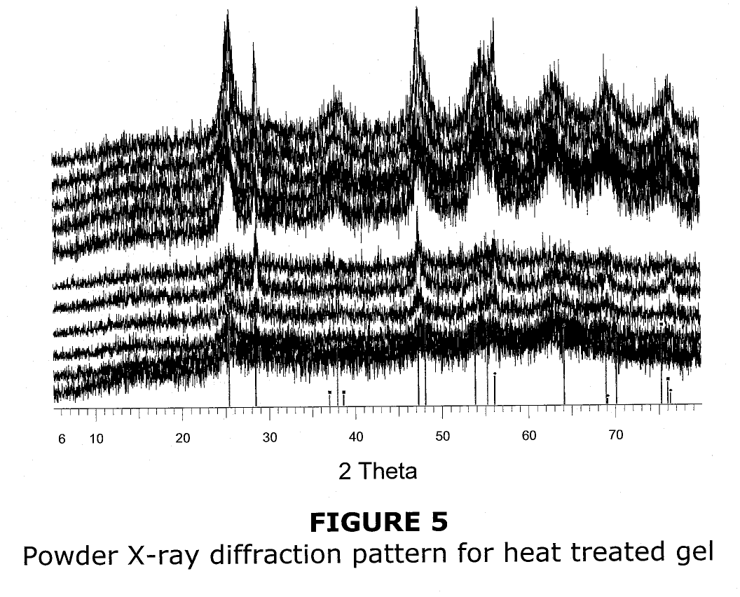

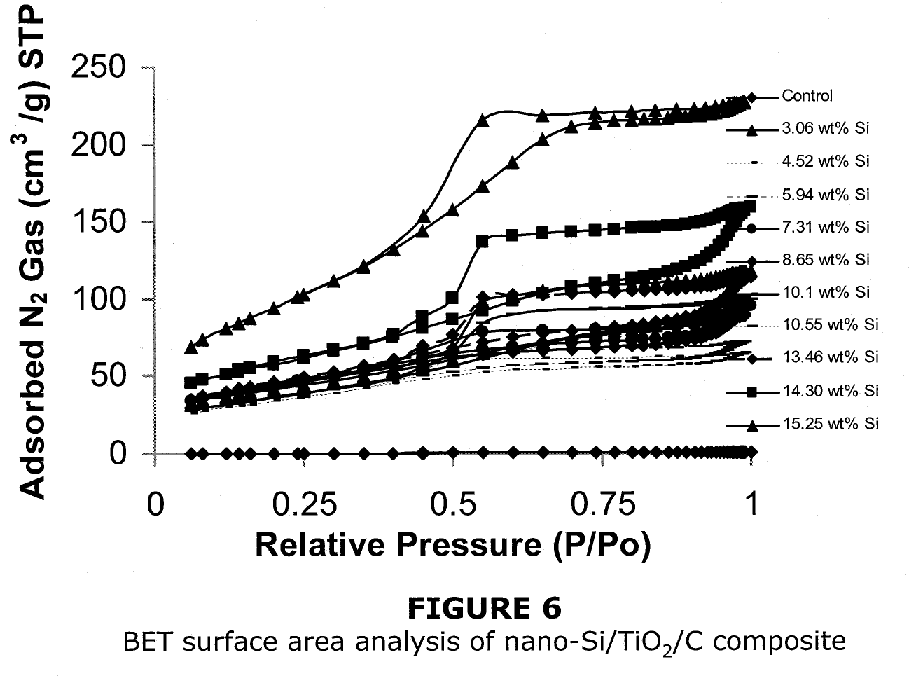

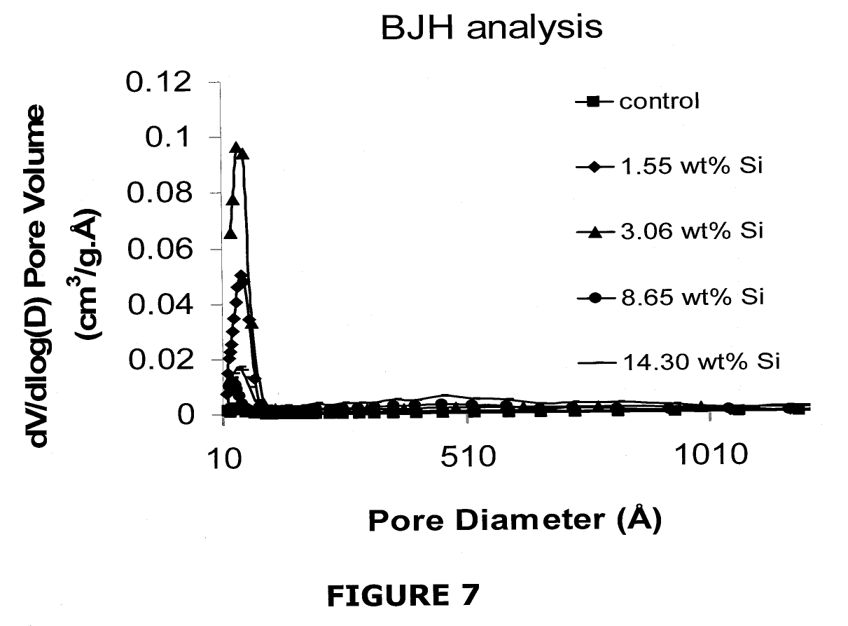

FIG. 5 shows a powder X-ray diffraction pattern for heat treated gel in 1% H₂/Ar atmosphere. The top pattern has the highest nano-Si content and the bottom is for the control sample without Si. FIG. 6 shows the surface area analysis of nano-Si/TiO₂/C composites by BET. FIG. 7 shows BJH analysis of the composites. The results of these analyses are given in Table 2.

TABLE 2

| | | | Average | | | | External |
|---|---|---|---|---|---|---|---|
| | | Surface | pore | Pore | Micropore | Micropore | surface |
| Sample | Si/TiO₂ | area | dia. | volume | volume | area | area |
| # | (%) | (m²/g) | (Å) | (cm³/g) | (cm³/g) | (m²/g) | (m²/g) |
| 1-1 | — | 29.56 | 33.56 | 0.020 | | | |
| 1-2 | 1.55 | 370.84 | 37.62 | 0.406 | | | |
| 1-3 | 3.06 | 351.31 | 37.20 | 0.377 | | | |
| 1-4 | 4.52 | 123.05 | 35.15 | 0.096 | | | |
| 1-5 | 5.94 | 128.86 | 37.81 | 0.106 | | | |
| 1-6 | 7.31 | 158.03 | 40.40 | 0.139 | | | |
| 1-7 | 8.65 | 153.87 | 40.49 | 0.129 | | | |
| 1-8 | 10.10 | 130.99 | 46.46 | 0.164 | | | |
| 1-9 | 10.55 | 132.48 | 49.37 | 0.169 | 0.0044 | 11.715 | 120.77 |
| 1-10 | 13.46 | 162.91 | 45.84 | 0.172 | 0.0044 | 12.489 | 150.42 |
| 1-11 | 14.30 | 207.15 | 49.89 | 0.241 | 0.0085 | 21.349 | 185.80 |
| 1-12 | 15.25 | 147.51 | 53.46 | 0.176 | 0.0089 | 20.629 | 126.88 |

The tap density of the Si nanoparticles is around 0.69 g/cc. When the nano-Si/TiO₂/P-123 gel was made, it formed a monolith that shrunk upon drying and further heat treatment, thereby increasing the tap density of the material. It is believed that the tap density of the nano-Si/TiO₂/C is higher than that of nano-Si starting material.

### Example 2

Electrochemical investigation of the heat treated material from Example 1 was carried out using a beaker cell (CV measurement) with working electrode made of ground powder with acetylene black and 1% CMC binder in a suitable ratio on stainless steel current collector and lithium metal on SS mesh as reference and counter electrode with 1M LiPF₆ EC:EMC (1:3 ratio) electrolyte. Swagelok cell test was performed to investigate voltage vs. capacity and cycle performance. The cathode was fabricated by coating a paste formed by fine heat treated powder, acetylene black and 1% CMC binder on surface cleaned Cu sheet and dried in an oven up to 120° C. for 2 hr. The resulting coated sheet was lapped and cut into 1 cm diameter circular disk. This individual disk was chosen as cathode and the cell was assembled using a lithium metal anode, a Celegrad separator, and 1M LiPF₆ in EC:EMC (1:3 ratio) as an electrolyte. A few cathodes were fabricated directly on 1 cm diameter nickel disk by pipette drop out of the active material, binder, and carbon mixture onto a disk, drying the disk in an oven up to 120° C., and pressing the disk at 1-2 ton pressure.

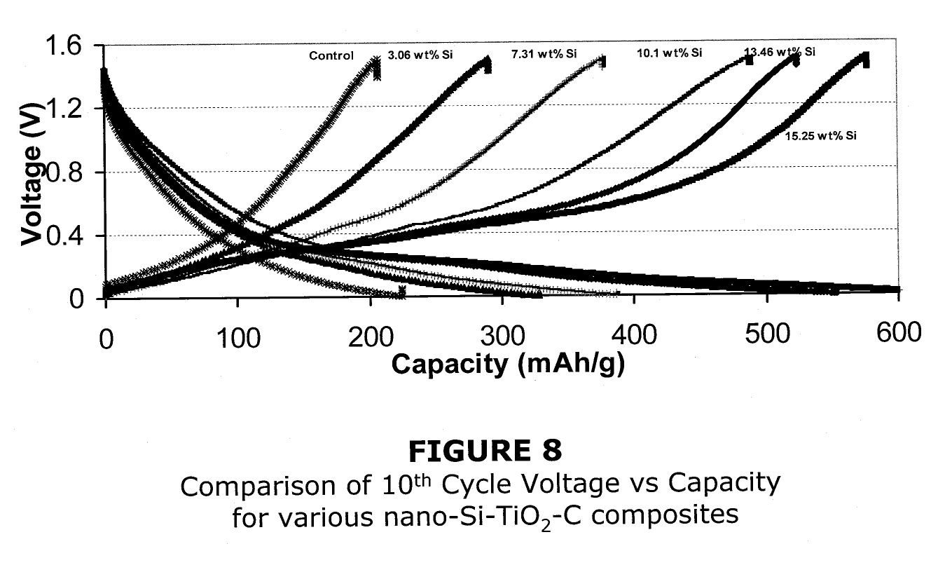

A comparison of 10th cycle voltage vs. capacity for various nano-Si/TiO₂/C composites is shown in FIG. 8.

### Example 3

This example illustrates the use of tin salts. The procedure of Example 1 was repeated except that SnCl₄.5H₂O was used. The resulting gel was heat treated under an atmosphere of 1% H₂ in Ar at the temperature shown in Table 3 to produce the nano-Sn/TiO₂/C electro-active composite. The preparations are shown in Table 3.

TABLE 3

| | Estimated | Titanium | | | | | |
|---|---|---|---|---|---|---|---|
| Sample | Sn/TiO₂ | iso-prop- | SnCl₄*5H₂O | H₂O | EtOH | | Heating |
| # | (%) | oxide (g) | (g) | (g) | (g) | pH^{a} | temp^{b} |
| 3-1 | 4.24 | 1.9 | 0.0603 | 0.2397 | 8 | <1 | 450° C. |
| 3-2 | 10.91 | 1.9 | 0.1668 | 0.4332 | 8 | <1 | 450° C. |
| 3-3 | 10.91 | 1.9 | 0.1668 | 0.4332 | 8 | <1 | 350° C. |
| 3-4 | 10.91 | 1.9 | 0.1668 | 0.4332 | 8 | <1 | 550° C. |

^{a}After 0.3 g of 0.5 M HCl addition
^{b}Under an atmosphere of 1% H₂ in Ar

### Example 4

Electrochemical valuation of the Sn/TiO₂/C composites was similar to that of Example 2. Swagelok cells, with a lithium metal cathode, an electrolyte of 1M LiPF₆ in EC:EMC (1:3), and a Celegrad separator were prepared. The 10 C charge and discharge capacity for the tenth charge and discharge cycle is shown in Table 4.

TABLE 4

| Heating Temp. | Charge Capacity^{a} | Discharge Capacity^{a} |
|---|---|---|
| 350° C. | 67 | 69 |
| 450° C. | 161 | 165 |
| 550° C. | 130 | 118 |

^{a}10th charge and discharge

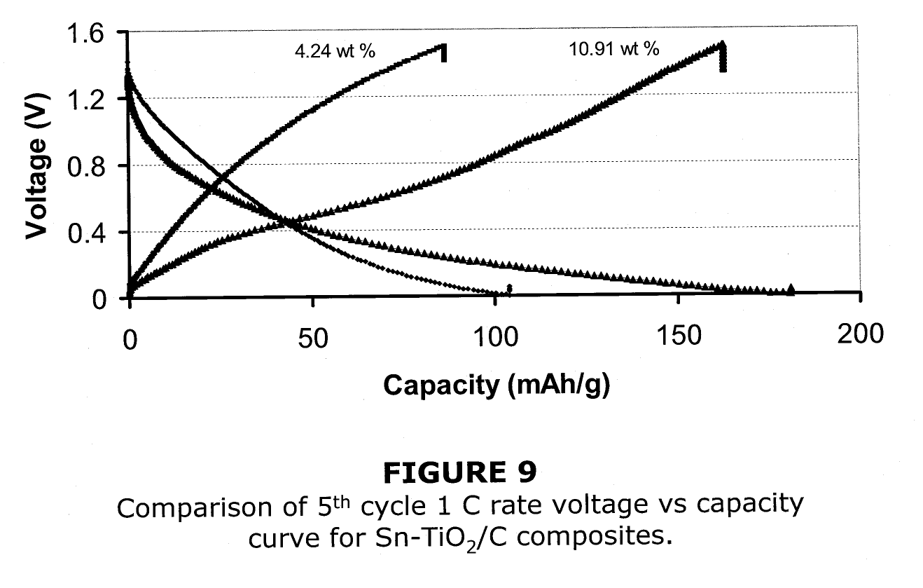

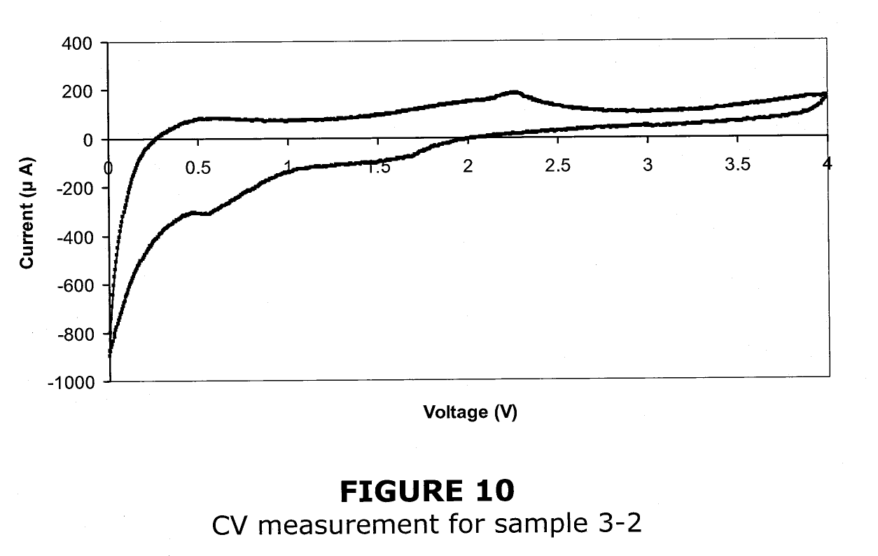

The 5^{th} cycle 1 C voltage vs. capacity curve for the Sn/TiO₂/C composites is shown in FIG. 9. The CV measurement for tin-containing sample 3-2 is shown in FIG. 10. The electrode composition was: active material (80), PVDF binder (10), and acetylene black (10). The scan speed was 1 mV/sec.

### Example 5

This example illustrates the synthesis of a series of other lithium absorbing materials including the nano-(Si/Al)/(Ti,Si/Al)Oₓ/C composites with nanoparticles of a lithium absorbing material using, for example, different amounts of silicon and aluminum and sample 5-1 and 5-2 are control samples.

One gram of P-123 was taken in 100 mL glass jar and 6 g of ethanol was added to the jar and the contents were stirred. The pH of the solution was adjusted by adding 0.3 g of 0.5 M HCl solution. Titanium isopropoxide, Al-isopropoxide and tetraethyl orthosilicate were taken in a vial (the amounts used are listed in Table 5) and 2 g of ethanol was added. This mixture was added drop wise with vigorous stirring under dry atmosphere, and the gel was slowly formed. The gel was aged for 24 hr and dried in an oven at 60° C.-80° C. for 2 hr. The preparations are shown below in Table 5.

TABLE 5

| | | | | HCl | Ti iso- | | Al iso- | Tetraethyl |
|---|---|---|---|---|---|---|---|---|
| Sample | | Si/Al | P-123 | (0.5 M) | propoxide | EtOH | propoxide | orthosilicate |
| # | Composition | (g) | (g) | (g) | (g) | (g) | (g) | (g) |
| Comp. 5-1 | Ti₁₋ₓAlₓO_{y} | | 1 | 0.3 | 1.33 | 8 | 0.408 | 0 |
| Comp. 5-2 | Ti₁₋ₓSiₓO_{y} | | 1 | 0.3 | 1.33 | 8 | 0 | 0.417 |
| 5-3 | Si/Ti₁₋ₓAlₓO_{y} | 0.0961 | 1 | 0.3 | 1.33 | 8 | 0.408 | 0 |
| 5-4 | Si/Ti₁₋ₓAlₓO_{y} | 0.211 | 1 | 0.3 | 1.33 | 8 | 0.408 | 0 |
| 5-5 | Si/Ti₁₋ₓSiₓO_{y} | 0.0961 | 1 | 0.3 | 1.33 | 8 | 0 | 0.417 |
| 5-6 | Si/Ti₁₋ₓSiₓO_{y} | 0.211 | 1 | 0.3 | 1.33 | 8 | 0 | 0.417 |
| 5-7 | Al/Ti₁₋ₓAlₓO_{y} | 0.0946 | 1 | 0.3 | 0.298 | 8 | 0.4072 | 0 |
| 5-8 | Al/Ti₁₋ₓAlO_{y} | 0.2092 | 1 | 0.3 | 0.315 | 8 | 0.4087 | 0 |
| 5-9 | Al/Ti₁₋ₓSiₓO_{y} | 0.0921 | 1 | 0.3 | 0.304 | 8 | 0 | 0.4171 |
| 5-10 | Al/Ti₁₋ₓSiₓO_{y} | 0.2028 | 1 | 0.3 | 0.306 | 8 | 0 | 0.4242 |

The dried gel was characterized using TG/DSC, powder XRD, and a SEM/EDX analysis system. The dried gel was then heat treated at 450-500° C. for 6 hr in 1% H₂/Ar atmosphere. The resulting black porous material was investigated using BET, powder XRD, SEM/EDX instruments, and electrochemical tests were performed using a Swagelok cell.

Examples 5-3 to 5-6 employed the above mentioned procedure along with nano-Si material mixed with a polymer (P-123) in the beginning. The dried gel was calcined at 500° C., 6 hr (10°/Min)-RT 100 mL/Min, under 1%-H₂—Ar mixture.

Example 5-7 to 5-10 used the above mentioned procedure along with nano-Al material mixed with a polymer (P-123) and the obtained gel was calcined at 450° C., 6 hr (10°/Min)-RT 100 mL/Min, under 1% H₂—Ar mixture.

Examples 5-1 and 5-2 are comparative examples without the use of nanoparticles of a lithium absorbing material.

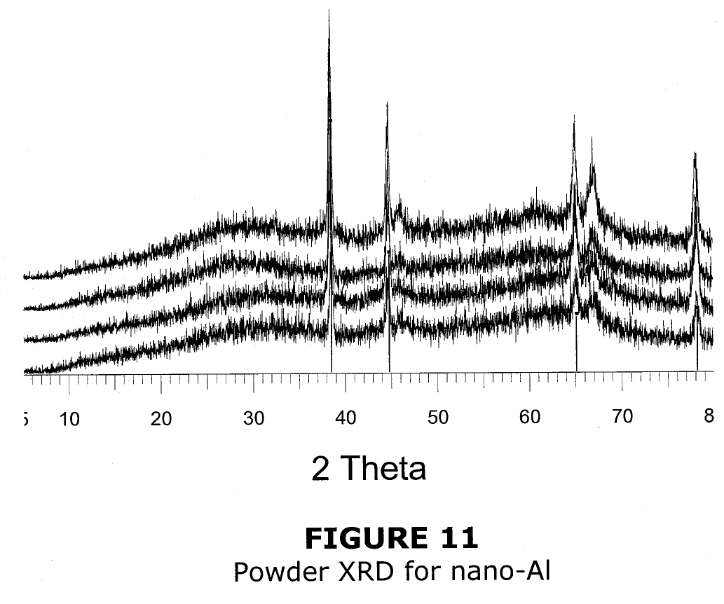

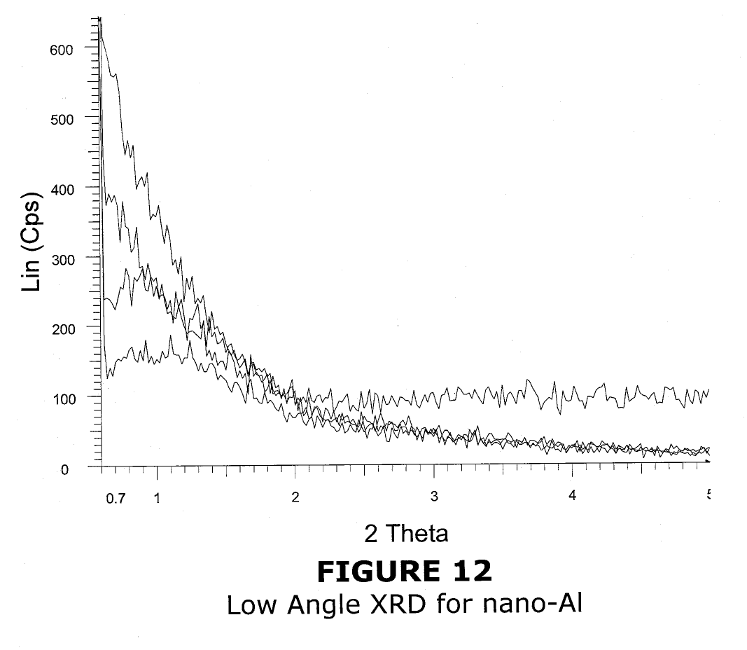

The powder XRD for the control samples (comp. 5-1 and comp. 5-2) showed no diffraction peaks at high angles indicating an amorphous nature of the material. The samples with nano-Si and nano-Al showed the presence of Si and Al and Al₂O₃, respectively. The Al₂O₃ in the latter is anticipated from the oxidized nano-Al rather than Al₂O₃ in the Ti₁₋ₓAlₓO_{y} matrix. The powder XRD for the nano-Al is shown in FIG. 11. Without being bound to a theory, the low angle diffraction did not show any sharp peaks and showed a broad hump for most of the samples which probably indicates the pores are not completely ordered as shown in FIG. 12 for the nano-Al samples.

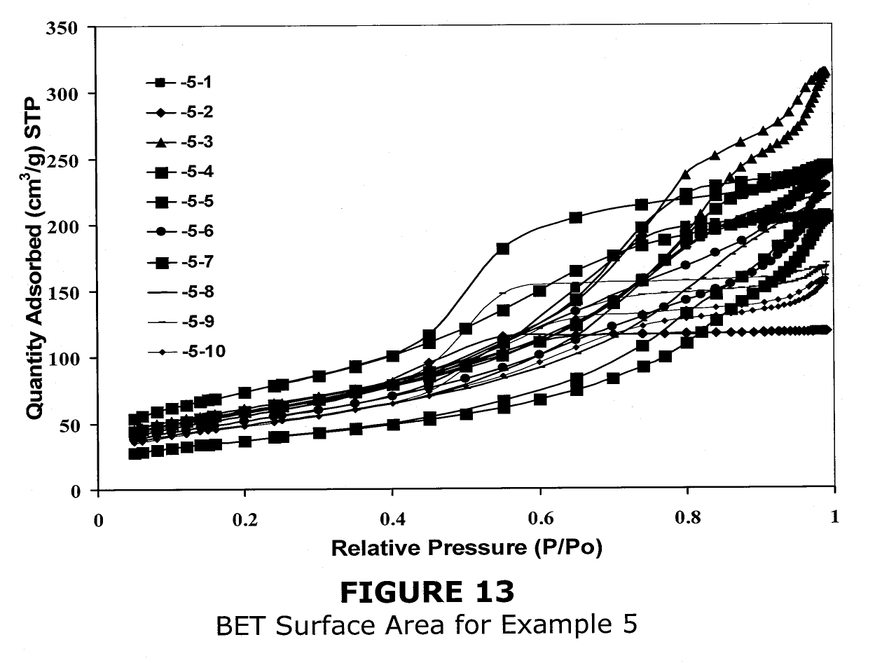

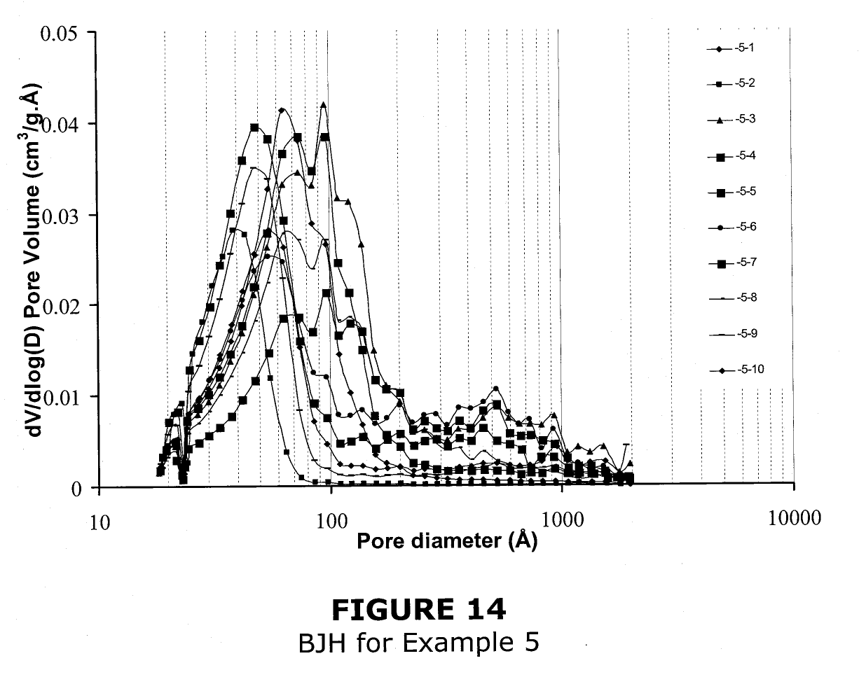

The BET surface area analysis of the samples shown in FIG. 13 shows a relatively high surface area. In FIG. 14, the BJH curve shows the presence of pores in the material and the major pore size distribution was below 150 Å and some big pores below 1000 Å were present in the samples with nano-Si and/or Al. Also, apart from the control samples (comp. 5-1 and comp. 5-2) all other samples have larger micro-pores of varied sizes that were detected in the BJH analysis. The results of the above described analyses are given in Table 6 and the density was measured by the Helium pycknometer.

TABLE 6

| Sample | | Surface area | Pore Width | Density |
|---|---|---|---|---|
| # | Powder XRD | (m²/g) | (Å) | (g/cc) |
| Comp. 5-1 | Amorphous | 209.9 | 60.72 | 3.33 |
| Comp. 5-2 | Amorphous | 203.2 | 36.15 | 2.99 |
| 5-3 | Nano-Si | 220.5 | 86.28 | 3.10 |
| 5-4 | Nano-Si | 134.1 | 93.34 | 2.94 |
| 5-5 | Nano-Si | 268.6 | 55.49 | 2.92 |
| 5-6 | Nano-Si | 188.4 | 74.09 | 2.79 |
| 5-7 | Nano-Al, Al₂O₃ | 214.4 | 69.69 | 3.26 |
| 5-8 | Nano-Al, Al₂O₃ | 176.01 | 77.08 | 3.20 |
| 5-9 | Nano-Al, Al₂O₃ | 209.99 | 48.7 | 3.08 |
| 5-10 | Nano-Al, Al₂O₃ | 173.76 | 54.66 | 3.07 |

The material was mixed with acetylene black and 1% Na-CMC binder solution in water and coated onto a current collector. The electrodes were dried at 80° C. for 1 hr, then vacuum dried at 120° C. for 2 hr, and pressed at 1-2 tons of pressure. The Swagelok cell assembly was constructed using Li foil as anode, Celgard separator and 1 M LiPF₆ solution in EC:EMC (1:3) solution electrolyte. Table 7 shows the composition and respective electrochemical cycle data (C/10 rate).

TABLE 7

| Sample | | | | | | |
|---|---|---|---|---|---|---|
| # | Composition | 1 cycle | 2 cycle | 3 cycle | 4 cycle | 5 cycle |
| Comp. 5-1 | Ti₁₋ₓAlₓO_{y} | 464/101 | 118/95 | 106/92 | 101/90 | 97/88 |
| Comp. 5-2 | Ti₁₋ₓSiₓOy | 577/133 | 159/127 | 145/122 | 134/124 | 130/124 |
| 5-3 | Si/Ti₁₋ₓAlₓO_{y} | 1085/468 | 504/379 | 364/255 | 229/159 | 140/118 |
| 5-4 | Si/Ti₁₋ₓAlₓO_{y} | 1533/824 | 866/629 | 632/472 | 468/367 | 350/280 |
| 5-5 | Si/Ti₁₋ₓSiₓO_{y} | 1275/535 | 635/535 | 557/483 | 501/443 | 455/400 |
| 5-6 | Si/Ti₁₋ₓSiₓO_{y} | 1861/1028 | 1145/896 | 971/776 | 816/660 | 683/580 |
| 5-7 | Al/Ti₁₋ₓAlₓO_{y} | 572/134 | 153/124 | 137/118 | 129/115 | 123/112 |
| 5-8 | Al/Ti₁₋ₓAlₓO_{y} | 1165/325 | 357/286 | 315/268 | 294/257 | 280/248 |
| 5-9 | Al/Ti₁₋ₓSiₓO_{y} | 722/212 | 227/186 | 195/171 | 178/161 | 168/154 |
| 5-10 | Al/Ti₁₋ₓSiₓO_{y} | 656/220 | 233/193 | 199/174 | 180/161 | 167/152 |

### Example 6

This example illustrates the synthesis of a series of nano-Si/TiO₂/C composites with the addition of carbon nano-tube (CNT).

Sample 8-1 was prepared as follows. 0.094 g of nano-Si was mixed with 9.034 g of P-123 and EtOH (1:8 ratio) solution and jar milled with 1 mm ZrO₂ balls for 24 h. The mixture was then added and 0.1 g of carbon nano-tube (CNT) was added. The mixture was sonicated for 20 minutes and cooled to room temperature and 0.3 g 0.5 N HCl was added and stirred well and 1.9 g of titanium iso-propoxide was slowly added. The resulting gel was dried in an oven at 80° C. for 1 hr and heat treated at 500° C. for 12 h under 1% H₂/Ar atmosphere. The electrochemical testing was performed as explained above for Example 5.

Sample 8-2 was prepared as follows. 0.2107 g of nano-Si, 0.0211 g was added to 1.005 g P-123 and EtOH solution and jar milled with 1 mm ZrO2 balls for 24 h. 0.0211 g of carbon nano-tube (CNT) was added and sonicated for 20 min. 0.314 g of 0.5 N HCl was added and stirred with slow addition of 1.5069 g of titanium isopropoxide. Again, electrochemical measurements were performed as explained in Example 5.

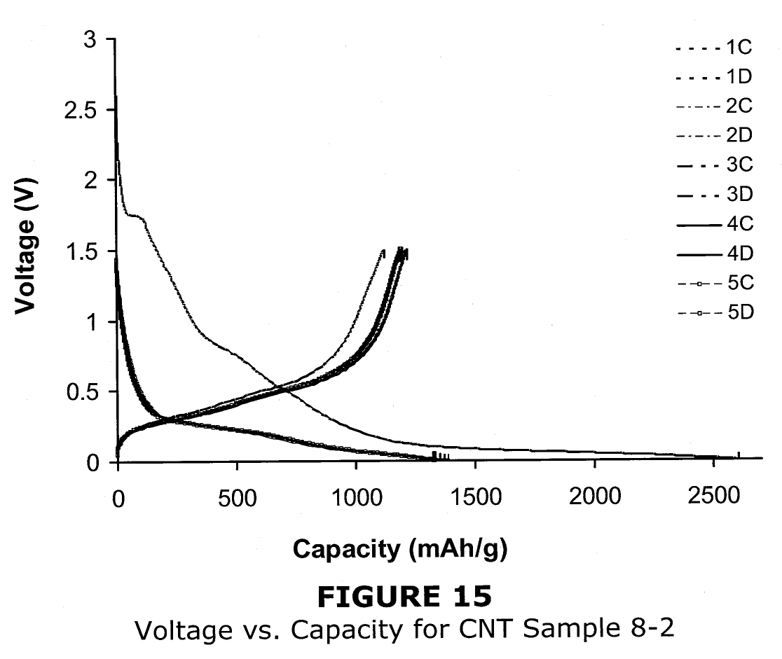

The voltage vs. capacity curve for the nano-Si/TiO₂/C composite with carbon nano-tube in sample 8-2 is shown in FIG. 15. Table 8 shows the composition and respective electrochemical cycle data (C/10 rate).

TABLE 8

| Sample | | | | | | |
|---|---|---|---|---|---|---|
| # | Composition | 1 cycle | 2 cycle | 3 cycle | 4 cycle | 5 cycle |
| 8-1 | Si/TiO₂—C-CNT | 1187/523 | 739/582 | 753/581 | 715/597 | 669/606 |
| 8-2 | Si/TiO₂—C-CNT | 2601/1122 | 1389/1215 | 1369/1217 | 1350/1218 | 1328/1218 |

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. An electrode of a non-aqueous electrolyte secondary battery, the electrode comprising:
a current collector; and
a mixture comprising an electrode active material, a conductive material, and a binder on the current collector;
in which:
the electrode active material comprises a porous oxide, in which the porous oxide comprises a lithium absorbing nano-material.

2. The electrode of claim 1, wherein the nano-material is a nano-dimensional material, a nanoparticle, or a nanotube.

3. The electrode of claim 1, wherein the lithium absorbing nano-material comprises tin, silicon, or aluminum in the porous oxide.

4. The electrode of claim 1, wherein the porous oxide is a metal or non-metal oxide.

5. The electrode of claim 1, wherein the porous oxide is a mesoporous network of titanium dioxide and the lithium absorbing nano-material is nanoparticles of a lithium absorbing material comprising tin nanoparticles or silicon nanoparticles.

6. An electrode of a non-aqueous electrolyte secondary battery, the electrode comprising:
a current collector; and
a mixture comprising an electrode active material, a conductive material, and a binder on the current collector;
in which:
the electrode active material comprises a porous network of an oxide, in which the porous network comprises nanoparticles of a lithium absorbing material.

7. The electrode of claim 6, wherein the nanoparticles of a lithium absorbing material is selected from the group consisting of tin nanoparticles, silicon nanoparticles, and aluminum nanoparticles.

8. The electrode of claim 6, wherein the nanoparticles of a lithium absorbing material comprise tin nanoparticles.

9. The electrode of claim 6, wherein the nanoparticles of a lithium absorbing material comprise silicon nanoparticles.

10. The electrode of claim 6, wherein the nanoparticles are partially amorphous.

11. The electrode of claim 6, wherein the porous network further comprises amorphous carbon.

12. The electrode of claim 6, wherein the porous network is a mesoporous network.

13. The electrode of claim 6, wherein the electrode active material further comprises carbon nanotubes.

14. The electrode of claim 6, wherein the electrode active material additionally comprises absorbed lithium.

15. The electrode of claim 6, wherein the porous network of the oxide is a porous network of titanium dioxide.

16. The electrode of claim 6, wherein the electrode active material comprises a mesoporous network of titanium dioxide and the nanoparticles of a lithium absorbing material comprise tin nanoparticles or silicon nanoparticles.

17. A non-aqueous electrolyte secondary battery comprising:
a positive electrode;
a negative electrode; and
a non-aqueous electrolyte between the positive electrode and the negative electrode;
in which:
the non-aqueous electrolyte comprises a non-aqueous solvent and lithium salt;
the positive electrode comprises a positive electrode current collector, and, on the positive electrode current collector, a mixture comprising a positive electrode active material, a first conductive material, and a first binder;
the negative electrode comprises a negative electrode current collector, and, on the negative electrode current collector, a mixture comprising a negative electrode active material, a second conductive material, and a second binder; and
either the negative electrode active material or the positive electrode active material comprises a porous network of an oxide, in which the porous network comprises nanoparticles of a lithium absorbing material.

18. The non-aqueous electrolyte secondary battery of claim 17, wherein the nanoparticles of a lithium absorbing material is selected from the group consisting of tin nanoparticles, silicon nanoparticles, and aluminum nanoparticles.

19. The non-aqueous electrolyte secondary battery of claim 18, wherein the tin nanoparticles, silicon nanoparticles, or aluminum nanoparticles comprise absorbed lithium.

20. The non-aqueous electrolyte secondary battery of claim 17, wherein the positive electrode active material comprises the porous network.

21. The non-aqueous electrolyte secondary battery of claim 20, wherein the nanoparticles of a lithium absorbing material comprise tin nanoparticles.

22. The non-aqueous electrolyte secondary battery of claim 20, wherein the nanoparticles of a lithium absorbing material comprise silicon nanoparticles.

23. The non-aqueous electrolyte secondary battery of claim 17, wherein the negative electrode active material comprises the porous network.

24. The non-aqueous electrolyte secondary battery of claim 23, wherein the nanoparticles of a lithium absorbing material comprise tin nanoparticles.

25. The non-aqueous electrolyte secondary battery of claim 23, wherein the nanoparticles of a lithium absorbing material comprise silicon nanoparticles.

26. The non-aqueous electrolyte secondary battery of claim 17, wherein the porous network is a mesoporous network

27. The non-aqueous electrolyte secondary battery of claim 17, wherein the porous network is a macroporous network.

28. The non-aqueous electrolyte secondary battery of claim 17, wherein the electrode active material further comprises carbon nanotubes.

29. The non-aqueous electrolyte secondary battery of claim 17, wherein the porous network is a mesoporous network of titanium dioxide and the nanoparticles of a lithium absorbing material comprise tin nanoparticles or silicon nanoparticles.

30. The non-aqueous electrolyte secondary battery of claim 17, further comprising a separator.

31. The non-aqueous electrolyte secondary battery of claim 17, wherein electrode active material additionally comprises absorbed lithium.
